(19) United States
(12) Patent Application Publication
(10) Pub. No.: US 2009/0103519 A1
(43) Pub. Date: Apr. 23, 2009

(54) Method and Computer Product for Switching Subsequent Messages With Higher Priority Than Invite Messages in a Softswitch

(75) Inventor: Uwe Grothe, Boynton Beach, FL (US)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens Aktiengesellschaft, Munich (DE)

(21) Appl. No.: 11/920,716

(22) PCT Filed: May 16, 2006
(86) PCT No.: PCT/EP2006/004599

§ 371 Date: Nov. 16, 2007

Related U.S. Application Data
(60) Provisional application No. 60/682,136, filed on May 18, 2005.

(51) Int. Cl. H04L 12/66

(52) U.S. Cl. 370/352

(57) ABSTRACT

A method for switching invite messages and subsequent messages in a softswitch directing the invite messages to a first list, and the subsequent messages to a second list. The method processes the subsequent messages of the second list with a higher priority than the messages of the first list.

### TECHNICAL FIELD

The present invention relates to a method for switching invite messages and subsequent messages in a softswitch.

### BACKGROUND OF THE INVENTION

The softswitch is used to control connections at the junction point between circuit and packet networks. The softswitch is a central device in a communication network which connects calls from one communication line to another. The switching takes place by means of software running on a computer system.

For establishing a session between an inviting party and an invited party a signalization procedure is processed before the user data can be transmitted between these parties. The protocol which is used for initiation a session is called SIP (session initiation protocol). In SIP an inviting party sends an invite message to the softswitch and the softswitch executes then the signalization procedure. If too many parties generate signalization traffic, the softswitch may also discard bye messages, which in turn is inefficient concerning the handling of session resources. I.e., session resources could be released but are not released because the bye messages have been discarded.

### SUMMARY OF THE INVENTION

One object of the invention is to provide a method for switching invite messages and subsequent messages in a softswitch with which it is made sure that also during huge signalization traffic the processing of messages related to existing sessions is assured.

An overload because of too many incoming requests should not lead to a degradation of the performance the softswitch. This means, that new call requests should not prevent call release messages from being processed by the softswitch.

According to one aspect of the invention, the object is achieved by a method for switching invite messages and subsequent messages in a softswitch with the features of the independent claim 1.

The method according to the invention for switching invite messages and subsequent messages in a softswitch comprises the following steps. The invite messages are directed to a first list and the subsequent messages are directed to a second list, whereas the subsequent messages of the second list are processed with a higher priority than the messages of the first list.

Advantageous further developments of the invention arise from the characteristics indicated in the dependent patent claims.

Preferably, in the method according to the invention the messages of the first list are processed, if the second list is empty.

Advantageously, in the method according to the invention the invite messages are directed by an inviting party to a first port of the softswitch, and the subsequent messages are directed by the inviting party to a further port of the softswitch.

An embodiment of the method according to the invention comprises the following step. After the softswitch has received an invite massage from the inviting party, the softswitch transmits a message to the inviting party indicating that the subsequent messages shall be send by the inviting party to the further port.

In another embodiment of the method according to the invention the subsequent message of the second list is added to the first list, if the subsequent message does not relate to an accepted session.

Furthermore, in the method according to the invention the subsequent message can be an acknowledge, bye, option or a cancel message.

For solving the object of the invention it is suggested that reading from the first list or the second list is executed by a session initiation protocol machine.

In a further embodiment of the method according to the invention the softswitch uses the session initiation protocol SIP.

Furthermore, a computer program element can be provided, comprising computer program code for performing steps according to the above mentioned method when loaded in a digital processor of a computing device.

Additionally, a computer program product stored on a computer usable medium can be provided, comprising computer readable program code for causing a computing device to perform the mentioned method.

### BRIEF DESCRIPTION OF THE DRAWINGS

The invention and its embodiments will be more fully appreciated by reference to the following detailed description of presently preferred but nonetheless illustrative embodiments in accordance with the present invention when taken in conjunction with the accompanying drawings.

The figures are illustrating:

FIG. 1 a block diagram of the softswitch according to the invention, and

FIG. 2 an example of a message flow.

### DETAILED DESCRIPTION OF THE DRAWINGS

The invention makes sure that VoIP SIP signaling messages related to an existing call, which is also referred to as accepted call, are processed before new calls are accepted.

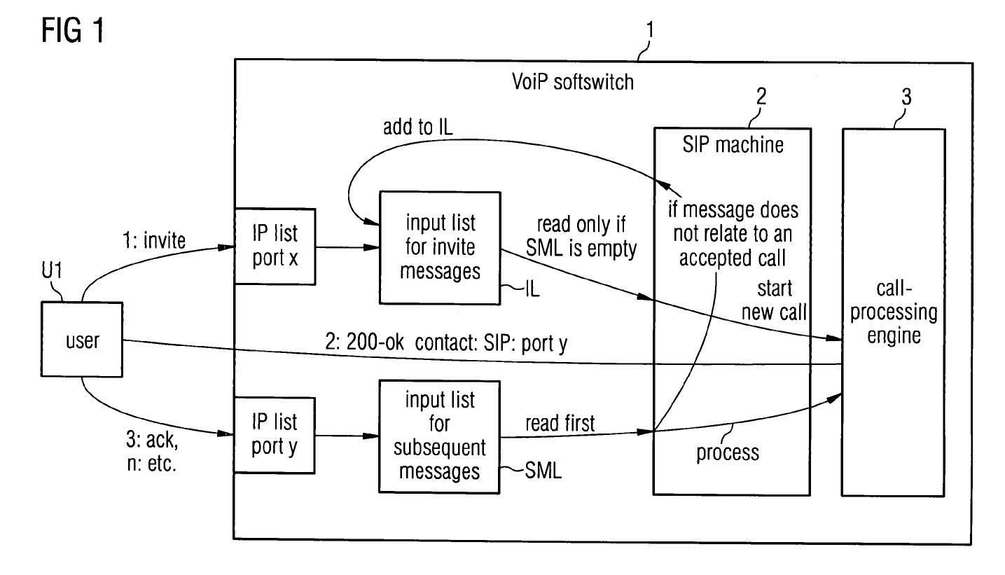

In FIG. 1 a block diagram of an embodiment of a softswitch 1 according to the invention is depicted. The softswitch 1 uses the voice over internet protocol (VoIP) SIP (session initiation protocol) as specified in RFC 3261 (http://www.ietf.org/rfc/rfc3261.txt).

In FIG. 1 a first party U1 wants to call second party U2. The first party U1, calling party or short caller, is the party initiating a session and a dialog with an invite request. The caller U1 retains this role from the time it sends the initial invite request that established a dialog until the termination of that dialog.

The second party U2 is hereinafter called invitee, invited user or called party. The called party U2 is the party that receives an invite request for the purpose of establishing a new session. The called party retains U2 this role from the time it receives the invite request until the termination of the dialog established by that invite request.

To establish a call, the caller U1 transmits in a first step 1: an invite message to an IP list port x. Port x forwards the invite message to a first list, which is called input list for invite messages IL. In general, the invite message is a request to invite a user or a service to a new session or to modify parameters of an established session. In FIG. 1 the invite message is a request to invite the second party U2 to establish a session.

It should be noted that the expression call is an informal term that refers to some communication between parties, and also for the purposes of a multimedia conversation.

A message is data, which is sent between SIP elements as part of the session initiation protocol. A SIP message is either a request from a client to a server, or a response from a server to a client.

A session is hereinafter a set of multimedia senders and receivers and the data streams flowing from senders to receivers. A multimedia conference is an example of a session. A session as defined for the session description protocol (SDP) can comprise one or more real-time trans-port protocol (RTP) sessions. A called party can be invited several times, by different calls, to the same session. If the session description protocol (SDP) is used, a session is defined by the concatenation of the SDP user name, session id, network type, address type, and address elements in the origin field. Further information about SDP can be found in RFC 2327 and in the Internet under the link http://www.ietf.org/rfc/rfc2327.txt.

In addition to the input list for invite messages IL the softswitch 1 comprises furthermore a second list, called input list for subsequent messages SML. Subsequent messages can be for example an acknowledge message, a 200-ok message, a cancel message, an option message, or a bye message.

The acknowledge message ack confirms that the session is established. The cancel message cancels a pending request. The bye message indicates the end of a session. The option message requests information about the capabilities of a server.

Before the softswitch 1 reads the input list for invite messages IL it checks whether the input list for subsequent messages SML is empty. If the input list for subsequent messages SML is not empty and the message stored in the input list for subsequent messages SML is not related to an accepted call, the SIP machine 2 of the softswitch 1 adds this message to the input list for invite messages IL. Afterwards the SIP machine 2 checks again if the input list for subsequent messages SML is empty and if applicable adds this further message to the input list for invite messages IL. In the case, the input list for sub-sequent messages SML is not empty and the message in input list for subsequent messages SML relates to an accepted call, this message is processed. These steps are repeated until the input list for subsequent messages SML is empty. The processing of the messages takes place in a call processing engine 3. If the input list for subsequent messages SML is empty, the input list for invite messages IL is read and the corresponding new call is started. Starting a new call takes also place in the call processing engine 3. The call processing engine 3 sends a message 200-ok . . . contact: SIP: . . . port y back to the inviting party U1, indicating that the invite message has been received and that subsequent messages, e.g., acknowledge, cancel or bye, shall be send from now on to another port y of the softswitch 1.

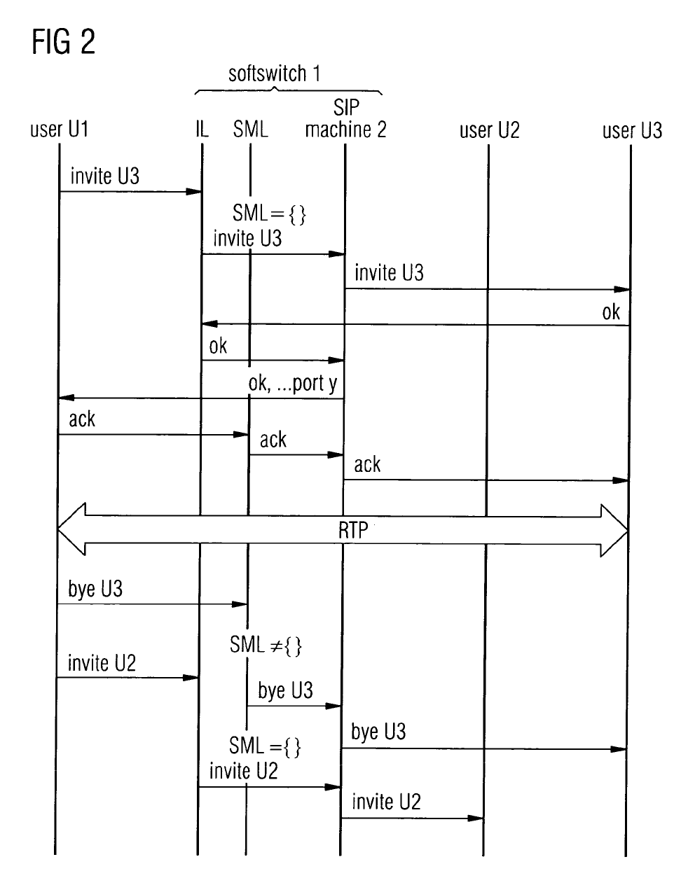

In FIG. 2 an example of a message flow is depicted. The example is simplified for better understanding. For exampie the trying message and the ring message of STP are not shown. In the example the calling party U1 wants to establish a session with the called party U3. Therefore, the calling party U1 sends an invite U3 message via port x to the input list for invite messages IL. In the example, the input list for subsequent messages SML is empty, which is indicated in FIG. 2 by SML={ }. AS the input list for subsequent messages SML is empty the invite U3 message is forwarded to the SIP machine 2, which in turn forwards the invite U3 message to the party U3. Thereupon, the party U3 sends an ok message, which is also indicted with 200-ok, back to the input list for invite messages IL of the softswitch 1. The ok message is forwarded to the SIP machine 2 and finally send to the calling party U1 together with the information that from now on all subsequent messages shall be send to port y. Thereupon, the calling party U1 sends an acknowledge message ack via port y to the input list for subsequent messages SML of the softswitch 1. Then, the acknowledge message ack is forwarded to the SIP machine 2 and from there to the invited party U3.

Now, the signaling is so far completed, the session is established, and the transfer of user data can start. The transfer of the user data can be done with the real-time transport protocol (RTP), which is controlled by the real-time transport control protocol (RTCP). The user data are transmitted in data packets on various ways, which are not controlled by the softswitch 1.

If the calling party U1 wants to terminate the session with the invited party U3, the calling party U1 sends a bye U3 message via port y to the input list for subsequent messages SML. In the example the calling party U1 wants to call instantaneously hereon a party U2, whereas the bye U3 message is still stored in the input list for subsequent messages SML and has not yet been processed. Therefore, the input list for subsequent messages SML is not empty, indicted in FIG. 2 by SML≠{ }. As mentioned above, foremost, the SIP machine 2 checks whether the bye U3 message corresponds to an existing call. Because this is the case, the SIP machine processes the bye message by forwarding it to the call processing engine 3. Now, the input list for subsequent messages SML is empty, indicted in FIG. 2 by SML={ }, and the invite U2 message can be read from the input list for invite messages IL and forwarded to the party U2. The remaining part of the signalization and user data transfer takes place as described above.

Having illustrated and described a preferred embodiment for a novel method for switching invite messages and sub-sequent messages in a softswitch, it is noted that variations and modifications in the method can be made without departing from the spirit of the invention or the scope of the appended claims.

### REFERENCE SIGNS

IL input list for invite messages
SML input list for subsequent messages
1 softswitch
2 session initiation protocol machine
3 call-processing engine
U1 first party
U2 second party
U3 third party

1. A method for switching invite messages and subsequent messages in a softswitch, comprising the following steps:
directing the invite messages to a first list;
directing the subsequent messages to a second list; and
processing the subsequent messages of the second list with a higher priority than the messages of the first list.

2. The method according to claim 1, wherein messages of the first list are processed, if the second list is empty.

3. The method according to claim 1, further comprising:
directing the invite messages by an inviting party to a first port of the softswitch; and
directing the subsequent messages by the inviting party to a further port of the softswitch.

4. The method according to claim 3, further comprising, after the softswitch has received an invite message from the inviting party, transmitting a message from the softswitch to the inviting party indicating that the subsequent messages shall be send by the inviting party to the further port.

5. The method according to claim 1, further comprising adding the subsequent message of the second list to the first list, if the subsequent message does not relate to an accepted session.

6. The method according to claim 1, wherein the subsequent message is one of an acknowledge, bye, option and a cancel message.

7. The method according to claim 1, wherein reading from the first list or the second list is executed by a session initiation protocol machine.

8. The method according to claim 1, wherein the softswitch uses the session initiation protocol.

9. A computer program element comprising computer program code for performing steps of a method for switching invite messages and subsequent messages in a softswitch when loaded in a digital processor of a computing device, the steps comprising:
directing the invite messages to a first list;
directing the subsequent messages to a second list; and
processing the subsequent messages of the second list with a higher priority than the messages of the first list.

10. (canceled)

11. A computer-readable medium storing computer-executable instructions that instruct a computer to perform steps of a method for switching invite messages and subsequent messages in a softswitch, the steps comprising:
directing the invite messages to a first list;
directing the subsequent messages to a second list; and
processing the subsequent messages of the second list with a higher priority than the messages of the first list.
